(19) United States
(12) Patent Application Publication
(10) Pub. No.: US 2012/0205571 A1
(43) Pub. Date: Aug. 16, 2012

(54) Glass fiber binder for aircraft insulation

(76) Inventor: Albert Lewis, Chino, CA (US)

(21) Appl. No.: 11/443,607

(22) Filed: May 30, 2006

(51) Int. Cl. C08K 5/11

(52) U.S. Cl. 252/62

(57) ABSTRACT

Glass fiber compositions are provided in the form of mats comprising a binder of thermoplastic polymer or other non-hazardous insulation material which resists high temperatures such as 2,000° F. for long periods.

A binder for a fiber insulation mat utilizes a high molecular weight resin polyacrylic acid polymer mixed with a catalyst such as sodium hypophosphite and triethonal to provide a bond. A silicone provides water repellency, a surfactant controls surface tension, and ammonia or an acid adjusts the pH and a silane.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BRIEF SUMMARY OF THE INVENTION

The present invention relates primarily to insulation fiber blankets, typically utilized in aircraft, to resist and prevent fire damage. The present invention provides glass fiber blankets for such purpose.

A binder of thermoplastic polymer provides good insulation. Acrylics constitute very good adhesive raw material. Certain other materials, additives and binders provide good surfactants with surface tension control, and other binders and additives provide very good results.

### BRIEF DESCRIPTION OF THE SEVERAL VIEWS OF THE DRAWINGS

Not applicable.

### DESCRIPTION OF THE PREFERRED EMBODIMENTS

It has been determined from development work that high temperature glass fiber mats comprising a binder made of thermoplastic polymer provides a good, non-hazardous aircraft insulating material, and temperatures as high as 2,000° F. have been achieved for long time periods. One of the binders for fiber insulation mats or blankets was prepared using a polyacrylic acid polymer. Acrylics have established themselves as a good adhesive raw material, because of their outstanding properties. Polyacrylic polymer was mixed with a catalyst comprising sodium hypophosphite and triethonal, a silane to provide a glass resin bond, a silicone to provide water repellancy, a surfactant to control surface tension, and ammonia or acid to adjust the pH. Good results were obtained with the above additives and other additives were used with similar results. Other binders were evaluated, including the use of polyvinyl acetate, polyvinyl chloride, epoxies, and polyesters.

Set forth hereinafter are a schedule of compositional ranges of binder formulations.

Compositional Range

| Ingredients | Parts by Weight |
|---|---|
| Polyacrylic resin | 0-200 |
| Hypophosphite | 0-2.50 |
| Triethonal | 0-6.50 |
| Silane | 0-6.0 |
| Silicone | 0-6.0 |
| Surfactant | 0-8.0 |
| Ammonia | 0-60 |
| Citric acid | 0-60 |
| Dye | 0-40 |
| Water | 1000 |

Set forth below are a number of specific binder formulations from the above Compositional Range, from which fiber insulation blankets were made and which have yielded good recovery properties and good water repellency:

| Ingredients | Parts by Weight | | | | | |
|---|---|---|---|---|---|---|
| Polyacrylic | 84.0 | 92.0 | 91.0 | 83.0 | 95.47 | |
| resin | | | | | | |
| Hypophosphite | 1.05 | 0 | 0 | 1.04 | 1.25 | |
| (ammonium/ | | | | | | |
| sodium) | | | | | | |
| Triethonal | 2.76 | 0 | 0 | 2.73 | 3.20 | |
| Silane | 4.2 | 1.83 | 2.73 | 4.17 | 4.00 | |
| Silicone | 3.4 | 3.67 | 4.55 | 5.0 | 8.00 | |
| Surfactant | 4.2 | 2.75 | 1.82 | 4.17 | 5.00 | |
| Ammonia | 50 | 30 | 30 | 25 | 30 | |
| Acid | 50 | 40 | 40 | 30 | 30 | {close oversize parenthesis} |
| (nitric/citric) | | | | | | |
| Dye | 40 | 50 | 10 | 10 | 20 | |
| Water | 1000 | 1000 | 1000 | 1000 | 1000 | |

Note:
The surfactant, ammonia, acid and dye may be varied as required.

Generally, the glass binders were prepared using particular specific polyacrylic resins having a molecular weight of 10,000 or higher, particularly Franklin International Acrylic Polymer resins and vinyl acrylic resins, to which were added various catalysts, silanes, silicones, surfactants and other binder materials.

Film properties are dependent not only upon the glass temperature of the polymer, but also on its molecular weight distribution. The K-value determined by viscosity measurement according to the Fikentscher method is often considered as a criterion for the molecular weight. Films of polymers of low molecular weight are less flexible, more tacky and normally less resistant to solvents than films of higher molecular weight.

The longer the alkyl chain in the ester group, the lower the water absorptivity of the acrylic polymer. The resistance to saponification depends on the nature of the alkyl substitutes. It increases with the size of the alkyl group and is particularly high when the alkyl group is branched.

Good adhesion to many substrates is usually obtained by inclusion of small amounts of an unsaturated carboxylic acid. Polymer dispersions which can be thickened with ammonia are obtained by polymerizing acrylic esters together with a small amount of acrylic acid.

Acrylics of high strength and excellent resistance to solvents are produced by including monomers which contain other reactive groups in addition to the vinyl group. Cross linking can be brought about between these groups either during the polymerization process or after the compound has been applied onto a substrate. Self-Cross linking acrylics can be utilized after the compound has been thus applied. The polymers are normally cross-linked by the application of heat or by means of high energy radiation.

Good recovery and water repellancy results were obtained by the use of the formulations earlier noted. In addition, there was virtually no smoke during the burn-through test. Further, there was no punking, and the results from the high temperature operation, produced no harmful fumes. In the course of the research effort, wide range of materials were investigated. The high temperature insulation values were obtained by the glass fiber with the binder being burned and creating very little smoke. It is intended to utilize the above noted binders with a high burn-through fiber blanket for the aerospace industry, and to use it in other commercial insulation applications.

Aqueous acrylic dispersions have important advantages over acrylic solutions in the applications of concern herein, these including lower costs, no solvent reclaiming, no toxic solvents, no fire hazards, ease of handling, higher solids content, and higher molecular weight at lower viscosity. In most applications, these; advantages outweigh the disadvantages, such as lower resistance to freezing, lower storage stability, longer drying time of film and higher water absorption of film.

The binder systems covered by this patent application can be cured, either thermally with no added catalyst or by the use of a catalyst only, or a combination thereof. To obtain good water repellency, it is necessary to properly cure the glass fiber batts with the above noted binders. A thermal cure temperature of 250° C. to 300° C. at a resident time of ten to twenty seconds as required depending on the amount of catalyst used.

It will be understood that various changes and modifications may be made from the preferred embodiments discussed above without departing from the scope of the present invention, which is established by the following claims and equivalents thereof.

1. An aircraft and commercial glass fiber insulation binder of a high molecular weight resin comprising about 84.0 parts polyacrylic resin, 1.05 parts sodium hypophosphite, 2.76 parts triethonal, 4.2 parts silane, 3.4 parts silicone, and 4.2 parts surfactant.

2. An aircraft and commercial glass fiber insulation binder of high molecular weight resin comprising about 92.0 parts polyacrylic resin, 1.83 parts silane, 3.67 parts silicone, and 2.75 parts surfactant.

3. An aircraft and commercial glass fiber insulation binder of a high molecular weight resin comprising about 91.0 parts polyacrylic resin, 2.73 parts of silane, 4.55 parts silicone, and 1.82 parts surfactant.

4. An aircraft and commercial glass fiber insulation binder of a high molecular resin comprising about 83.0 parts polyacrylic resin, 2.73 parts triethonal, 4.17 parts silane, 5.0 parts silicone, and 4.17 parts surfactant, and

5. An aircraft and commercial glass fiber insulation binder of a high molecular resin comprising about 95.0 parts polyacrylic resin, 1.04 parts sodium hypophosphite, 2.73 parts triethonal, 4.17 parts silane, 5.0 silicone, and 4.17 parts surfactant.

6. A thermoplastic polymer binder for high temperature glass fiber insulation blankets with good recovery properties and good water repellancy for use on aircraft, said binder comprising from 84.0 to 95.0 parts by weight of polyacrylic resin having a molecular weight of at least 10,000, from 1.83 to 4.17 parts by weight of silane, and from 3.4 to 8.0 parts by weight of silicone.
